(19) United States
(12) Patent Application Publication
(10) Pub. No.: US 2009/0031872 A1
(43) Pub. Date: Feb. 5, 2009

(54) Automatic Pill Cutter

(76) Inventor: Mark Lykam, Shirley, MA (US)

Correspondence Address: GORDON & JACOBSON, P.C., 60 LONG RIDGE ROAD, SUITE 407, STAMFORD, CT, 06902, US

(21) Appl. No.: 12/193,548

(22) Filed: Aug. 18, 2008

Related U.S. Application Data
(63) Continuation-in-part of application No. 10/796,490, filed on Mar. 4, 2004.

(51) Int. Cl. B26D 7/06

(52) U.S. Cl. 83/78

(57) ABSTRACT

An automatic pill cutter includes mechanisms for bringing pills to a cutting location, for centering and locating the pills at the cutting location, and for cutting and dispensing the cut pills.

This application is a continuation-in-part of U.S. Ser. No. 10/796,490 having a filing date of Mar. 4, 2004 and which is hereby incorporated by reference herein in its entirety.

### BACKGROUND OF THE INVENTION

1. Field of the Invention

This invention relates generally to an improved pill cutter. More particularly, this invention relates to a pill cutter capable of cutting pills of various shapes and sizes.

2. State of the Art

It is generally well-known that on numerous occasions, particularly with respect to children, that a half or a quarter of a pill is prescribed. Normally, in such an event, an attempt is made to divide the pill by placing it on a support surface and then attempting to cut or split the pill with a sharp instrument such as a knife. Generally, this results in the pill or the pieces thereof being scattered about the immediate area. Anyone who has attempted to split a pill in half, or a quarter, will readily attest to these facts.

### SUMMARY OF THE INVENTION

According to one aspect of the invention, a pill cutter is provided which can cut most shapes and diameters of pills.

According to another aspect of the invention, a pill cutter is provided which can cut pills ranging in diameter from ⅛ to ½ inch without replacing any parts.

According to a further aspect of the invention, a pill cutter is provided which directs the cut pills so that they can be collected at one point.

In accord with these objects which will be discussed in detail below, the pill cutter of the present invention includes an indexing wheel and left and right hand torsion fingers which center the pill for cutting. The indexing wheel accommodates a variety of pill sizes and pushes the pill out from the cutting area after it is cut.

The indexing wheel of the present invention has first and second angled walls for centering the pill, and a top wall for stabilizing the pill or holding it as a cutting blade moves upward and downward at the cutting location. Removing or changing the indexing wheel is simple and quick as it is held down with only a thumb screw.

### BRIEF DESCRIPTION OF THE DRAWINGS

FIG. 1 is a perspective view of a pill cutter according to the invention;

FIG. 2 is a right side elevation view;

FIG. 3 is a sectional view taken along line 3-3 in FIG. 1;

FIG. 4 is a sectional view taken along line 4-4 in FIG. 3 showing the bottom of the indexing wheel;

FIGS. 4A through 4D are partial bottom plan views of the indexing wheel as it moves through one quarter of a turn;

FIG. 5 is a top plan view of the indexing wheel, partially broken away to reveal the torsion fingers;

FIG. 6 is a sectional view taken along line 6-6 in FIG. 5;

FIG. 7 is a broken perspective view of the underside of the indexing wheel showing the angled centering walls; and

FIG. 8 is a sectional view taken along line 8-8 in FIG. 3 showing the centering walls with a pill being biased against them by the torsion fingers.

### DETAILED DESCRIPTION OF THE PREFERRED EMBODIMENT

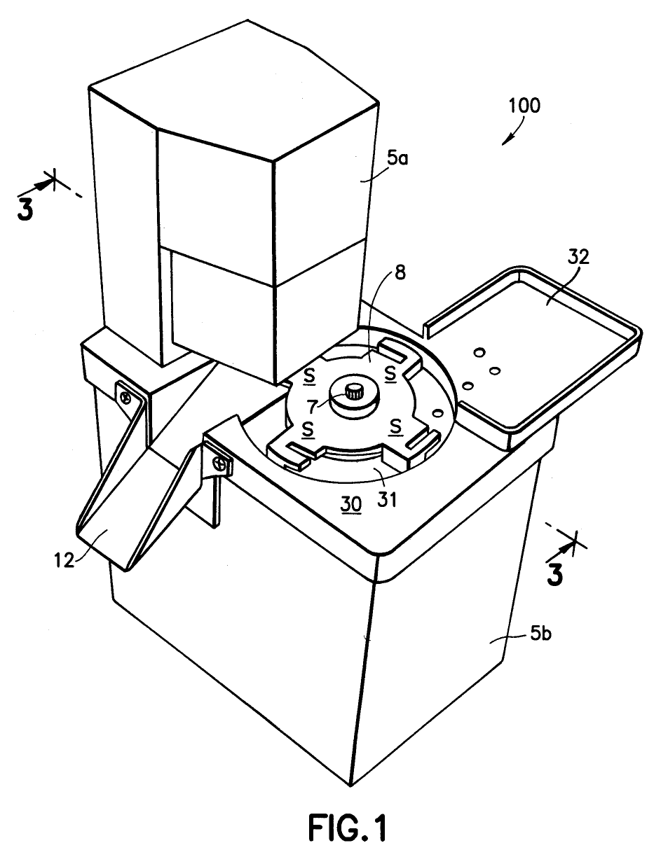

A pill cutter 100 is best seen in FIGS. 1-3. As will be described in detail below, the pill cutter 100 broadly includes mechanisms for bringing pills to a cutting location, for centering and locating the pills at the cutting location, and for cutting and dispensing the cut pills. More particularly, an indexing wheel 8 is preferably used for bringing the pills to the cutting location; the indexing wheel 8 and torsion spring arms 10a, 10b are used for centering and locating the pills at the cutting location; and a cutting blade 16 which is activated by solenoid 1 is used to cut the pills, which are then dispensed by movement of the indexing wheel 8.

More particularly, the pill cutter includes a solenoid 1 (FIG. 3) located in upper housing 5a. The solenoid 1 is provided to move a plunger 3 up and down slides 4a, 4b. Plunger 3 includes a blade slot 6 into which blade 16 is inserted and held in place by one or more screws 38. More particularly, as seen best in FIG. 3, the blade slot 6 is preferably provided with a set screw 38 to selectively hold and release the blade 16. The set screw may be loosened to release the blade 16 for replacement and may be tightened on the replacement blade. It can also be seen in FIG. 3 that the solenoid-activated plunger 3 is provided with a return spring 40. When the solenoid 1 is activated (as hereinafter described) the plunger 3 moves down against the force of the spring 40 and the blade 16 cuts the pill. When the solenoid is deactivated, the spring 40 lifts the plunger up moving the blade out of the way so that the next pill can be moved into position. Blade 16 may be a standard razor blade or other type of blade. Spring 40 is optional, as the solenoid and/or other circuitry (not shown) can be used to electronically lift the plunger 3.

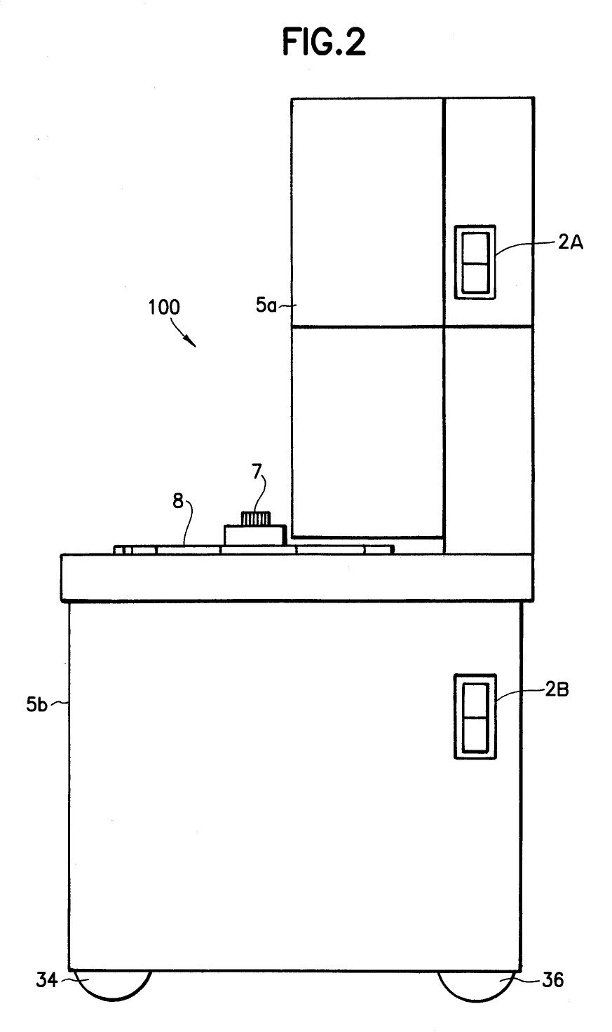

The pharmaceutical pills are brought into position for cutting by the indexing wheel 8 which is held in place by the thumb screw 7 connected to the indexing wheel shaft 9. As shown in FIG. 2, upper and lower switches 2A and 2B are provided as power controls for the solenoid and the indexing wheel. Thus, when the pill cutter 100 is plugged in, lower switch 2A (located on lower housing 5b) may be toggled to an ON position to cause the indexing wheel mechanism 8 to start rotating. Similarly, switch 2B located on upper housing 5a may be toggled to an ON position to permit movement of the blade. Both switches are optional.

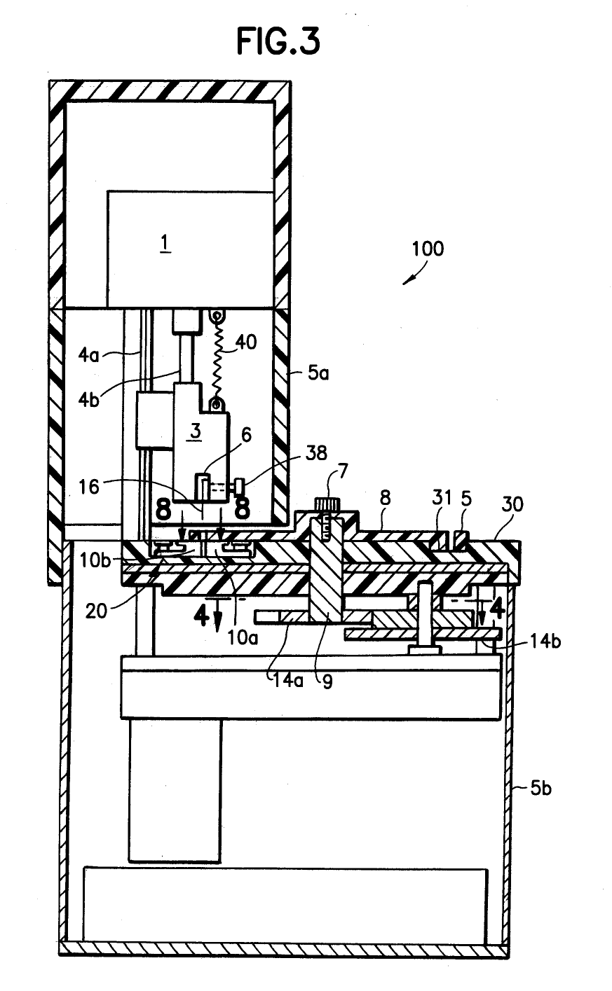

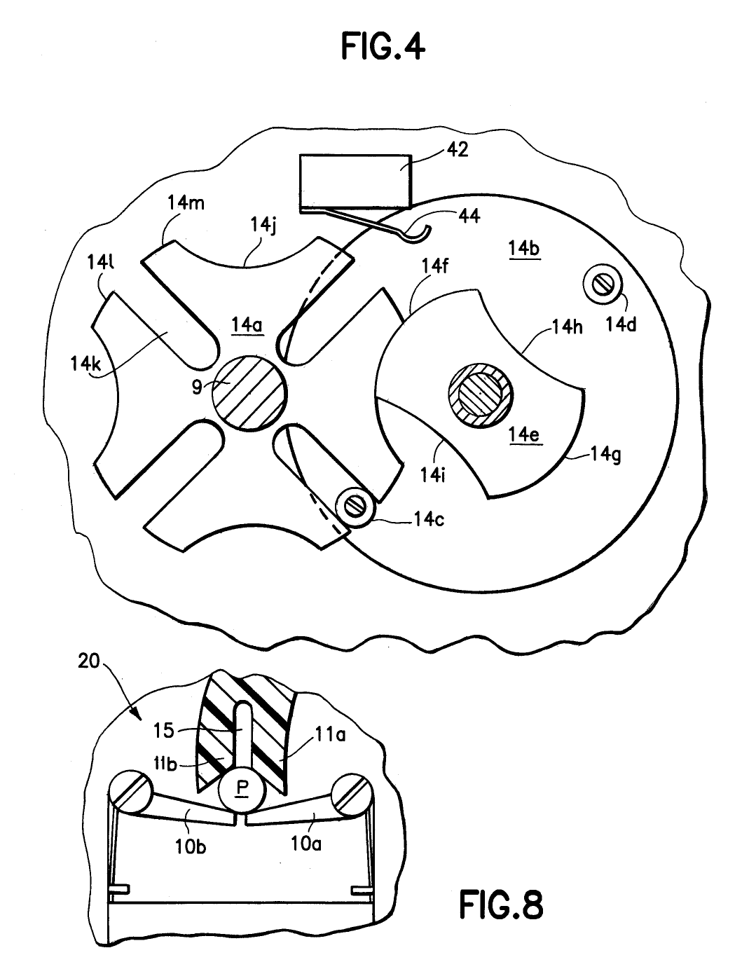

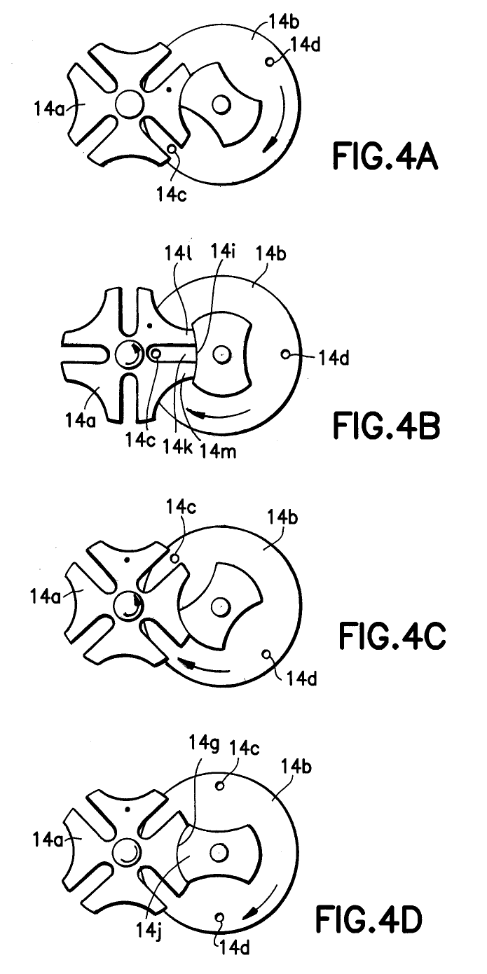

FIGS. 1 and 5 illustrate the top of the indexing wheel 8 and some of its related functional parts. The indexing wheel 8 is a plate having, e.g., four stations S which collect and center a pill and rotate it to the cutting location. The indexing wheel 8 is coupled to and rotated by shaft 9. As seen best in FIGS. 3 and 4, the shaft 9 is turned by a “driven wheel” 14a of a “Geneva drive”. The wheel 14a is driven in an indexed manner by a drive wheel 14b having a pair of drive pins 14c, 14d. As seen best in FIGS. 1 and 3, a thumb screw 7 is used to allow the plate 8 to be properly adjusted relative to the drive wheel 14a, or removed and replaced with another plate which can accommodate pills of different size and/or shape. The indexing wheel plate 8 resides atop a table 30 having a recessed track 31, and the pills are held by the stations S of the plate as hereinafter described and the table 30. Table 30 is also optionally held in place by thumb screw, such that the table can be removed and replaced with another table for accommodating pills of different size and/or shape. As illustrated in FIG. 1, an optional pill tray 32 is arranged adjacent to the table 30. The tray 32 may be stationary in which case the pills will be manually transferred from the tray 32 to the table 30. Alternatively, the tray 32 may be a vibrating tray which can automatically transfer pills to the table 30.

Referring now to FIGS. 4 and 4A-4D, it will be appreciated that the driving wheel 14b has a central hub 14e which has two convex surfaces 14f, 14g and two concave surfaces 14h, 14i. The driven wheel 14a has four concave surfaces, e.g. 14j, and four slots, e.g. 14k, between concave surfaces. The apparent arms flanking each slot have outward ends, e.g. 14l, 14m, which have convex outer surfaces. FIG. 4D illustrates the positions of the wheels 14a, 14b when the indexing wheel 8 is in the position shown in FIG. 5. The convex surface 14g of the driving wheel hub engages the concave surface 14j of the driven wheel. This locks the driven wheel into position preventing the indexing wheel 8 from moving. As the driving wheel continues to move, it moves out of the position shown in FIG. 4D toward the position shown in FIG. 4A. The convex surface of the hub begins to disengage the concave surface of the driven wheel and the pin 14c enters the adjacent slot. As the wheels continue to turn, the convex surfaces of the arms adjacent the slot enter the concave surface of the hub as seen in FIG. 4B. The concave surface 14h (or 14i) of the hub 14e allows the arms to rotate past it. At this point the driving wheel has rotated one quarter of a turn (ninety degrees) and the driven wheel has rotated one eighth of a turn (forty-five degrees). The pin 14c has bottomed out in the slot 14k. As the driving wheel continues to rotate (causing the driven wheel to rotate) from the position of FIG. 4B to the position of FIG. 4C, the pin 14c eventually exits the slot (thereby effectively temporarily disengaging the driving wheel from the driven wheel) and the convex surface 14f (or 14g) of the hub begins to engage the next concave surface of the driven wheel as shown in FIG. 4C. At this point, the driving wheel has rotated three eighths of a turn (one hundred thirty-five degrees) and the driven wheel has rotated one-quarter of a turn (ninety degrees). Each ninety degree rotation of the driven wheel 14a causes another of the four stations S to be located under the blade 16 as will be described hereinafter.

As seen in FIG. 4, a switch 42 is provided with a spring arm contact 44. As the driving wheel 14b rotates, pins 14c and 14d will intermittently hit arm contact 44, thereby closing switch 42. As a pin 14c or 14d passes the arm contact 44, the arm will spring back out, thereby opening switch 42. Switch 42 is coupled to the solenoid 1 via circuitry (not shown). Thus, every time an arm closes switch 42, the plunger 3 will be actuated such that the blade 16 will move downward to cut a pill, and every time switch 42 is opened, the plunger 3 will be free to move back upwards under force of the spring 40.

As will be appreciated, rotation of the driving wheel 14b from the position of FIG. 4C to the position of FIG. 4D results in the pin 14c engaging (and disengaging) the arm contact 44, thereby causing switch 42 to close and open. In addition, because the driven wheel 14a is not engaged with the driving wheel during this forty-five degrees of rotation, the opening and closing of switch 42 and the movement of the blade occurs as the driven wheel 14a is stationary. Thus, as the driving wheel 14b rotates one-half turn (one hundred eighty degrees), the driven wheel 14a rotates one quarter turn (ninety degrees) and moves half of the time and is stationary for half of the time.

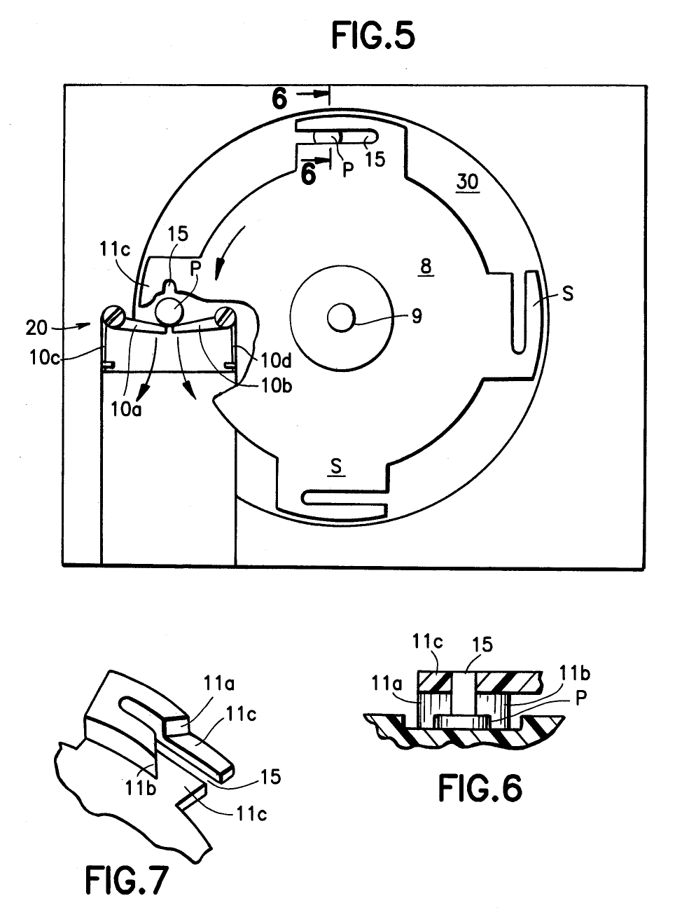

As seen best in FIGS. 5-8, during operation, a pill P (typically moved from table 32 (FIG. 1) onto table 30 is collected into a station S (by rotation of table 8) such that the pill P is flanked by two angled centering walls 11a, 11b and under a top wall 11c. Top wall 11c defines a cutting groove 15 which is wide enough to accept blade 16. In a preferred embodiment, the centering walls 11a, 11b are angled at about forty-five degrees, and are approximately 0.2 inches tall (i.e., the top wall 11c is about 0.2 inches above track 31) to provide clearance for a pill of 0.187 inch thickness. As wheel 8 rotates with a pill collected in a station, the pill is eventually taken to the cutting location 20 where the torsion fingers 10a, 10b help hold the pill in place. While the indexing wheel is stationary, and with the pill centered at the cutting location 20, a pin of the driving wheel 14b closes switch 42 (FIG. 4) thereby actuating the solenoid 1, which causes the plunger 3 having blade 16 (FIG. 3) to move downward. When the blade 16 moves downward, it extends into the cutting groove 15 and cuts the pill P in half at the cutting location 20. As the pill is cut, the top wall 11c of station S prevents the pill from flying off the wheel 8. After the pill is cut, the plunger 3 and blade 16 are retracted prior to renewed movement of the indexing wheel. This occurs as the driving wheel 14b moves an additional forty-five degrees from the position in FIG. 4D to the position of FIG. 4A. Then, as the other pin of the driving wheel 14b engages the driven wheel 14a, the indexing wheel 8 again starts to rotate to bring another pill to the cutting location 20. At the same time, the sum of the parts of the cut pill will push past the torsion fingers 10a, 10b and travel down the pill slide 12 (FIG. 1). If desired, the cut pieces can be collected in a bottle or other container (not shown). The torsion fingers 10 include right and left torsion fingers 10a and 10b with springs 10c, 10d which cause the fingers 10a, 10b to spring back in place after the pill pieces push past them.

It should be appreciated that the angled centering walls 11a, 11b of the cutting stations S, and the track 31 of table 30 allow for the accommodation and centering of pills of different size. Thus, in the preferred embodiment, track 31 is slightly larger than ½ inch wide, and the stations S with walls 11a and 11b are sized to ride in the track so that pills ranging in diameter from ⅛ to ½ inch are easily accommodated. When the centering walls are adjacent the torsion fingers as seen in FIGS. 5 and 8, the pill is embraced between the torsion fingers and the centering walls so that the pill is centered. The overlying wall 11c which defines cutting groove 15 effectively prevents the pill from scattering when it is being cut at the cutting location 20.

The pill cutter 100 is optionally provided with one or more vibration absorbing pads, two of which 34, 36 can be seen in FIG. 2. The pads are preferably hemispheres which are placed one on each corner of the bottom of the machine 100 with an adhesive. The vibration absorbing pads reduce the shock to the pill cutter 100 which results when the blade 16 impacts the pill P. In this manner, it is less likely for the pill pieces (which are in any event restrained by wall 11c) to scatter.

There have been described and illustrated herein an embodiment of a pill cutter. While a particular embodiment of the invention has been described, it is not intended that the invention be limited thereto, as it is intended that the invention be as broad in scope as the art will allow and that the specification be read likewise. Thus, while a particular indexing wheel driven by a Geneva wheel has been disclosed, it will be appreciated that other indexing wheels and different driving mechanisms could be used as well. For example, instead of having four stations, the indexing wheel could have a different number of stations. Also, instead of utilizing a driving mechanism which causes the indexing wheel to move half the time and remain stationary half the time, driving mechanisms having other “duty cycles” could be used. In addition, while the cutting mechanism was described as including a solenoid which actuates a plunger to which is coupled a blade, it will be understood that other mechanisms can be used to move the blade up and down. For example, and not by way of limitation, a motor and pulley system could be used. Also, while a table and indexing wheel which accommodates pills of between one-eighth inch and one-half inch in diameter is preferred, it will be recognized that the table track (channel) could be wider or narrower and accommodate different sized pills, and the height of the stations could be changed to accommodate thicker (or thinner) pills. It will therefore be appreciated by those skilled in the art that yet other modifications could be made to the provided invention without deviating from its spirit and scope as claimed.

1. An automatic pill cutting device for cutting pills, the device comprising:
a rotating indexing wheel which brings the pills to a cutting location;
torsion fingers at the cutting location which help in centering the pills before cutting; and
a blade for cutting the pills while stopped at the cutting location.

2. An automatic pill cutting device according to claim 1, wherein said torsion fingers include right hand and left hand torsion fingers.

3. An automatic pill cutting device according to claim 1, wherein said torsion fingers are spring loaded to allow cut pills to pass through and exit when said rotating indexing wheel moves the cut pills past the cutting location.

4. An automatic pill cutting device according to claim 1, wherein the indexing wheel holds said pills down and in place at the cutting location after said pills are cut.

5. An automatic pill cutting device according to claim 1, wherein the indexing wheel handles multiple pill sizes without change of the wheel itself.

6. An automatic pill cutting device, according to claim 1, further comprising:
a Geneva wheel mechanism which drives the indexing wheel, wherein the indexing wheel is removably coupled to the Geneva wheel mechanism.

7. An automatic pill cutting device, according to claim 1, further comprising:
a solenoid that causes said blade to move up and down in order to cut said pills.

8. An automatic pill cutting device according to claim 1, wherein said rotating indexing wheel can accommodate pills which do not exceed 0.187 inches in thickness and 0.500 inches in diameter.

9. An apparatus for cutting pills, comprising:
a cutting blade; and
an indexing wheel assembly arranged below the cutting blade, said indexing wheel assembly including a plate having a plurality of pill receiving locations and an indexing means for causing the plate to repeatedly rotate and stop said pill receiving locations in a position under said cutting blade, wherein said cutting blade moves in a plane perpendicular to said plate in order to cut pills located in said pill receiving locations and stopped under said cutting blade.

10. An apparatus according to claim 9, wherein:
said indexing means comprises a Geneva wheel.

11. An apparatus according to claim 9, wherein:
said plate includes a plurality of cutting grooves each flanked by angled centering walls.

12. An apparatus according to claim 11, wherein:
said plate includes top walls overlying said angled centering walls, said cutting grooves extending through said top walls, said top walls holding the pills down in place upon cutting by said cutting blade.

13. An apparatus according to claim 11, further comprising:
a pair of torsion fingers arranged below the cutting blade such that when said indexing wheel brings a pill into position for cutting, said torsion fingers bias the pill against the centering walls.

14. An apparatus according to claim 11, wherein:
said indexing means comprises a Geneva wheel.
